(19) United States
(12) Patent Application Publication
(10) Pub. No.: US 2020/0232439 A1
(43) Pub. Date: Jul. 23, 2020

(54) Pressurized Hydro-Electric Generator System

(71) Applicant: Charles Michael Blankenship, Tallahassee, FL (US)

(72) Inventor: Charles Michael Blankenship, Tallahassee, FL (US)

(21) Appl. No.: 16/743,253

(22) Filed: Jan. 15, 2020

Related U.S. Application Data
(60) Provisional application No. 62/794,820, filed on Jan. 21, 2019.

(51) Int. Cl. F03B 13/06; H02K 7/18

(52) U.S. Cl. CPC F03B 13/06; H02K 7/1823

(57) ABSTRACT

The present invention provides for a pressurized hydro-electrical generating system that uses pressurized water contained in a sealed tank to rotate a turbine assembly, thereby rotating an armature of electro-magnetic coils around a shaft to produce electrical energy. The low cost system uses a limited amount of water as to conserve the valuable resource of water.

### CROSS-REFERENCE TO RELATED APPLICATIONS

This non-provisional application claims the benefit of previously filed provisional application No. 62/794,820 filed on Jan. 21, 2019 entitled “PRESSURIZED HYDRO-ELECTRIC GENERATOR SYSTEM” of which the contents are hereby incorporated in their entirety.

### FIELD

The instant invention relates to a generating system to provide for electrical power, more specifically to hydro-electric power generation using pressurized water contained within a sealed tank. Water driven electrical generator systems are numerous in prior art that contain flowing water. The prior art does not address the containment of water to be recirculated under pressure within the structure, as the present invention describes.

### BACKGROUND OF THE INVENTION

A hydro-electric generator system, whereby kinetic power is derived from the potential of pressurized water driving a turbine assembly. The kinetic power will be developed from the water, under pressure, driving the turbine depending on the water volume and the pressure of the water. The water will be contained within a tank, then delivered, under pressure from a pumping mechanism, to the turbine assembly through a penstock, tubing or pipes. The water tank will be attached to the structure and sealed, whereas to retain the pumped water within the tank, then recirculating the water in the tank by the pumping mechanism. The turbine assembly will have a shaft that will connect through a hub at one end. On such hub will be attached a Pelton wheel, or an array of such wheels, inside the water tank. The other end of the shaft will be connected to an armature of electromagnetic coils and magnets, outside of the water tank. The turbine assembly is rotated around the shaft, thereby turning the armature, thereby producing electric energy. The present invention may be used in absence of a river, ocean, or the like, for its water supply with a minimum of water in use, therefore not wasting the valuable resource of water. Furthermore the present invention can be a standalone hydro-electric generating system, or may be grid- tied, or connected to a storage system, such as batteries, for future consumption and can be scaled to size for desired energy needs.

### SUMMARY OF THE INVENTION

One of the objectives is to provide for a low cost system to generate electric power that can scale to size depending on power requirements or needs,

An additional object is to use pressurized water for efficient potential of power,

A further object is to be an eco-friendly system that doesn't pollute the environment, conserves water and does not increase greenhouse gases,

Furthermore, the present invention overcomes some of the shortfalls of the prior art.

### BRIEF DESCRIPTION OF THE DRAWINGS

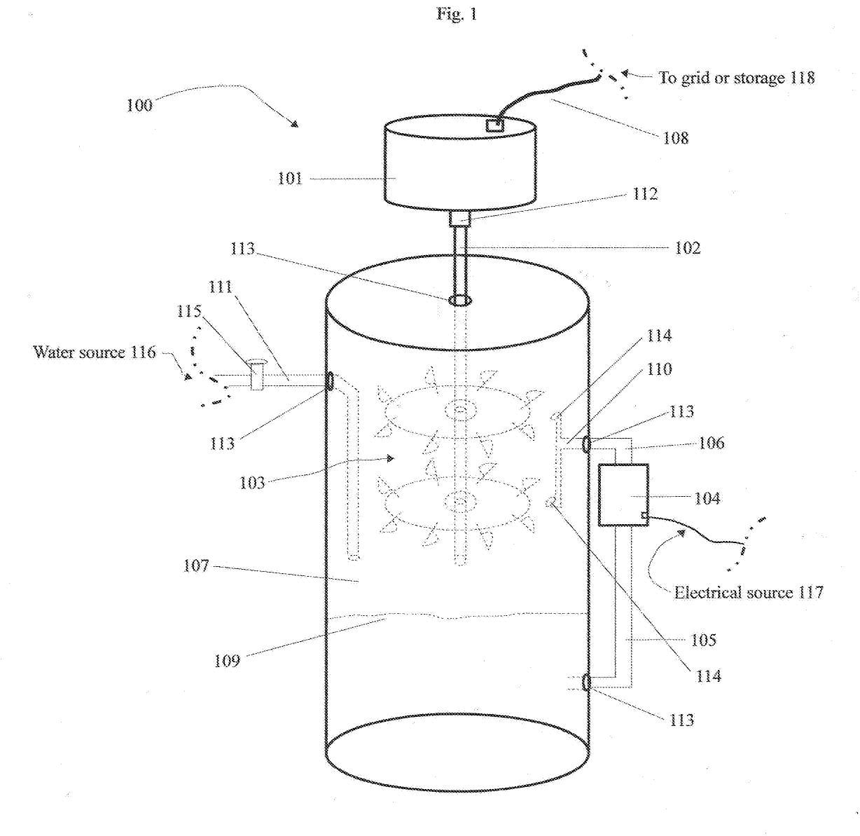

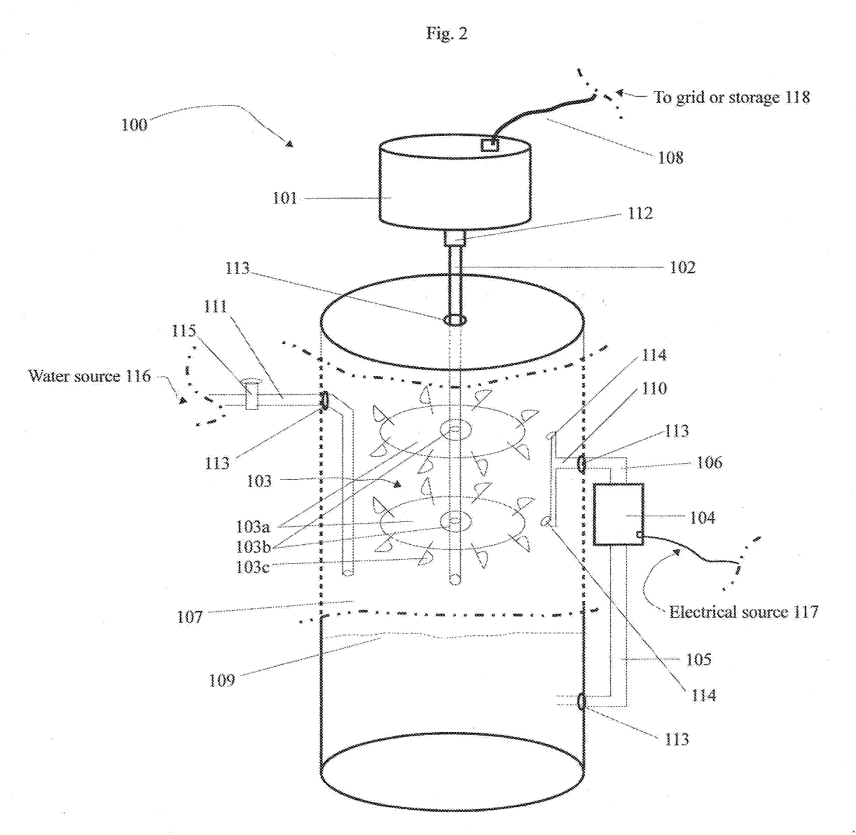

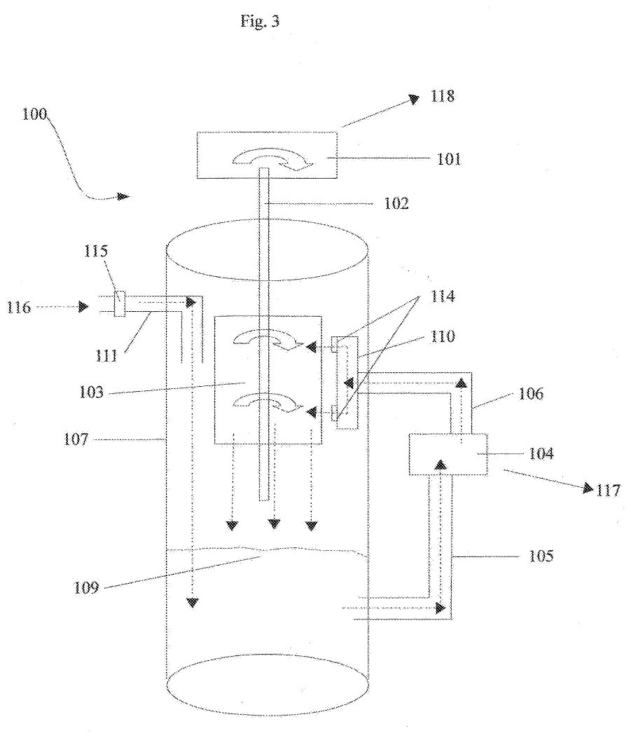

In the following detailed description the present invention will be explained in more detail with reference to the embodiments shown in the drawings,in which: FIG. 1 is a schematic diagram of the present invention, and FIG. 2 is a cut away view of FIG. 1 showing the turbine assembly and the nozzle manifold, and FIG. 3 is a flow chart of the working process of the present invention.

### DETAILED DESCRIPTION

The following is a detailed description of the present invention as described in the embodiments. A first embodiment as shown in FIG. 1 is to illustrate the parts of the present invention. The pressurized hydro-electric generator system 100 is comprised of a sealed tank 107 having a plurality of sides and ends, in which contains a volume of water 109 necessary for the proper operation of said system 100. The external water source 116 will fill said water 109 into said sealed tank 107, through the manually operated water fill valve 115, moving said water 109 through a water fill pipe 111, which extends into said tank 107 through one of the plurality of tank seals 113, until the volume of said water 109 reaches a satisfactory level needed for operation of said system 100, then said water valve 115 is manually closed. The said water 109 will be contained interior of said sealed tank 107 during the operation of said system 100, reducing the volume of water needed, thereby saving the valuable resource of water. The pressurized hydro-electric generator system 100 further comprises a water pump inlet pipe 105, having 2 ends, where one end will extend into said tank 107 through one of said tank seals 113 then connect at the other end of said pipe, to the electrical water pump 104. Said pump 104 will be external of said sealed tank 107 and connected to an external electrical power source 117. Said pump 104 will pressurize said water 109 and connect to water pump outlet pipe 106 on one of two ends of said outlet pipe 106. Said pipe 106, will pass through one of said tank seals 113 and extend into said tank 107. The other end of said pipe 106 will connect to the nozzle manifold 110, internal of said tank 107. Said system 100 further comprises a shaft 102, having two ends, and attaches at one end, by means of a connector 112 to the armature assembly 101. Said shaft 102 will pass through one of said tank seals 113 and attach to said turbine assembly 103, internal of said sealed tank 107. Said armature assembly 101 will be a series of coils, or a stator, positioned around a rotor or shaft containing magnets such as, but not limited to, a permanent magnet generator or an alternator. Said armature assembly 101 will be connected to a distribution cable 108 which will then connect to the external power grid or storage 118.

A second embodiment as shown in FIG. 2 are the internal parts of the pressurized hydro-electric generator system 100, comprising said nozzle manifold 110, which will be internal of said sealed tank 107, connected to said water pump outlet pipe 106, and contain an array of pipes having a plurality of nozzles 114 at the end of said pipes. Further comprising the nozzles 114 that will deliver said water 109 towards said turbine assembly 103, more specifically at the plurality of turbine blades 103c. Further, said turbine blades 103c will be attached to a plurality of Pelton wheels 103a, or as such. Each of said Pelton wheels, or as such, will be attached to a hub 103b which will be secured to the said shaft 102. Said Pelton wheels 103a, or as such, will be perpendicular to said shaft 102.

A third embodiment is the actual workings of the present invention as shown in FIG. 3. The pressurized hydro-electric generator system 100 being comprised of the parts in the before mentioned embodiments, operates by manually opening said water fill valve 115, allowing the flow of water 109 from said water source 116 through said water fill pipe 111. After the necessary volume of said water 109 is in said sealed tank 107, said water fill valve 115 is manually closed. Said water 109 then flows into the water pump inlet pipe 105, then into the electrical water pump 104, which is powered by an external power source 117. Further said pump 104 pressurizes said water 109 and pumps into the water pump outlet pipe 106, where said water 109 will flow into said nozzle manifold 110. Said water 109 will be delivered, under pressure, through the nozzles 114 to the turbine assembly 103. Said turbine assembly 103, being connected to the shaft 102, will rotate said shaft 102. Said shaft 102, at one end, is connect to the armature assembly 101 thereby rotating said armature assembly 101. The rotation of said armature assembly 101 produces the electrical energy that will be transmitted through said distribution cable 108 which is connected to the grid or storage 118. Said water 109 will be contained in said sealed tank 107 and continuously recirculated through said system, thereby delivering a constant amount of energy as needed.

It should be noted that the pressurized hydro-electric generator system 100 may be scaled by any number of the following factors, but not limited to: increasing the plurality of the Pelton wheels 103b or such; increasing the size of the Pelton wheels 103b or such; increasing the plurality of the turbine blades 103c, or such; increasing the volume of water 109; increasing the pressure of the water 109; increasing the size and scope of the armature assembly 101 or such, as ways to increase the kinetic power derived from the present invention.

The mentioning of the singular or plural of any item does not exclude the other. The pressurized hydroelectric generator system and the drawings contained herein, are not to scale.

What is claimed is:

1. A method of generating electric energy, the method comprising: a pressurized hydro-electric generating system thereby generating electrical energy from a generator or rotating machine; said generator or rotating machine containing a plurality of electromagnetic coils rotating in relation to a permanent magnet rotor; said generator or rotating machine being energized by a rotating turbine assembly connected to the shaft of said generator or rotating machine; said turbine assembly being rotated by pressurized water; said pressurized water being pumped against said turbine assembly from a pumping mechanism which is powered by an external power source; said water is contained within a sealed tank or reservoir for the purpose of recirculating said water continually to said turbine by means of said pumping mechanism, thereby producing the desired electrical energy from said system for: 1) use; 2) delivery to the electric grid; or 3) storage.

2. The method of claim 1, further comprising: wherein said system can be scaled as to the amount of energy desired from said system by increasing the rotational speed of said turbine by: 1) increasing the pressure of said water; 2) increasing the volume of said water; or 3) increasing the pressure of said water and the volume of said water.

3. The method of claim 1, further comprising: wherein said system's desired energy output can be scaled by increasing the size and capacity of said generator or rotating machine's electromagnetic capability.

4. The method of claim 1, further comprising: wherein said system's desired output can be increased by the addition of a plurality of turbines in said turbine assembly.

5. The method of claim 1, further comprising: wherein said system's desired energy output can be increased by connecting a plurality of said systems in combination or configurations to maintain a desired level of energy output.

6. The method of claim 1, further comprising: wherein operating said system by recirculation of said water contained in said sealed tank is an efficient and effective manner as to conserve the valuable natural resource of water.

7. The method of claim 1, further comprising: wherein operating said system will reduce or eliminate emissions of greenhouse gases and other environmentally hazardous elements.

8. The method of claim 1, further comprising: wherein said system will be of economical cost of construction and operation.

9. The method of claim 1, further comprising: wherein said system can be of use as: 1) a stationary device to generate desired electrical energy output; or 2) a mobile device to generate desired electrical energy output.
